(19) United States
(12) Patent Application Publication
(10) Pub. No.: US 2009/0059827 A1
(43) Pub. Date: Mar. 5, 2009

(54) System, Method and Apparatus for Asynchronous Communication in Wireless Sensor Networks

(75) Inventors: Yonghe Liu, Arlington, TX (US); Mohan J. Kumar, Euless, TX (US); Sajal K. Das, Denton, TX (US)

Correspondence Address: CHALKER FLORES, LLP, 2711 LBJ FRWY, Suite 1036, DALLAS, TX, 75234, US

(73) Assignee: Board of Regents, The University of Texas System, Austin, TX (US)

(21) Appl. No.: 12/203,539

(22) Filed: Sep. 3, 2008

Related U.S. Application Data
(60) Provisional application No. 60/969,901, filed on Sep. 4, 2007.

(51) Int. Cl. G08C 17/00

(52) U.S. Cl. 370/311

(57) ABSTRACT

The present invention provides a system, method and apparatus for asynchronous communication in wireless sensor networks. Each sensor includes a transmitter normally operating in a sleep mode, a low power receiver having a memory, a sensing module, and a processor normally operating in a sleep mode communicably coupled to the transmitter, the low power receiver and the sensing module. Data is received via the low power receiver and stored in the memory. Whenever a wakeup time occurs, the transmitter and the processor are put in an operational mode, sensory data is obtained from the sensing module, the sensory data is processed, the received data is obtained from the low power receiver memory, the processed sensory data and the received data are transmitted via the transmitter, and the transmitter and the processor are put in the sleep mode.

### PRIORITY CLAIM

This patent application is a non-provisional application of U.S. provisional patent application 60/969,901 filed on Sep. 4, 2007 and entitled “System, Method and Apparatus for Asynchronous Communication in Wireless Sensor Networks,” which is hereby incorporated by reference in its entirety.

### FIELD OF THE INVENTION

The present invention relates generally to the field of wireless communications and, more particularly, to a system, method and apparatus for asynchronous communication in wireless sensor networks.

### BACKGROUND OF THE INVENTION

Wireless sensor networks have attracted a plethora of research efforts due to their vast potential applications. In contrast with traditional data forwarding networks, wireless sensor networks for a large portion of applications are often characterized by extremely low data rates [1, 2]. For instance, common sensory data typified by humidity, temperature, and pressure can often be precisely quantified using only a few bytes. While numerous ground-breaking research has been performed in this area, including those for localization, synchronization, security, in-network signal processing, and data storage and query, the underlying communication techniques, particularly at the physical and link layers, are still largely germinating along the Internet root and its wireless extensions.

Notably, the IEEE 802.11 protocol, which has long been proven to be neither energy efficient nor ad-hoc operation friendly [3-6], still remains the root of a majority of MAC layers for wireless sensor networks, including S-MAC [7-9], T-MAC [10], B-MAC [11], P-MAC [12], etc. In these schemes, carrier sensing and collision avoidance based on random backoff are employed as the fundamental media access mechanism. Energy efficiency, on the other hand, has mainly relied on coordinated sleep/wakeup schemes [7, 9, 10, 13-21], where sensor nodes wakeup periodically in a synchronized fashion to communicate with each other. Unfortunately, besides the overhead for sleep/wakeup synchronization, by constricting all nodes' communications into a short time window, this method will inevitably augment the collision probability and irrelevant packet listening. These effects will be particularly more severe for large scale wireless sensor networks.

Indeed, a few approaches toward new communication schemes in wireless sensor networks have been proposed. Notably among them are a set of projects, for example PicoRadio at UC-Berkeley [22, 23], Radio-triggered sensor network at University of Virginia [24], and Wake-on-Wireless at Microsoft [25] that have proposed to employ a second lower power radio module. This lower power module is intended to wake up the main radio upon the reception of signaled communication intention from the transmitter. However, wakeup radio for wireless sensor networks are still largely experimental study (such as PicoRadio [22, 23]), or theoretical analysis [24], or targeting at different type of networks [25]. Notice that the second radio is for wakeup only, not data reception.

Nowadays, energy efficiency in wireless sensor networks is overwhelmingly relying on coordinated sleep/wakeup at the underlying physical and link layers. Although some of these methods have used “asynchronous wakeup” for MAC layer design [26], they are not truly asynchronous because they allow a sensor node to remain awake long enough so that it can overlap with awake period of a neighboring node when communication occurs. Moreover, the media access control mechanisms are mainly still rooted in the 802.11 protocol, which has long been proven to be neither energy efficient nor ad-hoc operation friendly.

Accordingly, there is a need for a system, method and apparatus for asynchronous communication in wireless sensor networks that allow sensor node to independently transmit without requiring any synchronized sleep/wakeup.

### SUMMARY OF THE INVENTION

The present invention employs lower power radio and store-and-forward processes to provide an asynchronous communication architecture for wireless sensor networks, where sensor nodes are allowed to independently transmit without requiring any synchronized sleep/wakeup. Specifically, the transmitter directly writes data into a special module residing on the receiver while it is asleep. This way, each individual sensor can schedule its own transmission without demanding network wide or local synchronization. The result is a store-and-forward, asynchronous communication pattern in the network. Owing to the low duty cycle of a sensor node, this architecture can dramatically reduce collisions and idle listening by fully exploiting time as an additional dimension of resource and hence achieve significant energy efficiency.

One embodiment of the present invention provides a method for communicating within a wireless network of sensors. Each sensor includes a transmitter normally operating in a sleep mode, a low power receiver having a memory, a sensing module, and a processor normally operating in a sleep mode communicably coupled to the transmitter, the low power receiver and the sensing module. Data is received via the low power receiver and stored in the memory. Whenever a wakeup time occurs, the transmitter and the processor are put in an operational mode, sensory data is obtained from the sensing module, the sensory data is processed, the received data is obtained from the low power receiver memory, the processed sensory data and the received data are transmitted via the transmitter, and the transmitter and the processor are put in the sleep mode. Note that this method can be implemented using a computer program embodied on a computer readable medium wherein the steps are performed by one or more code segments.

Another embodiment of the present invention provides a sensor that includes a transmitter, a low power receiver, a sensing module and a processor communicably coupled to the transmitter, the low power receiver and the sensing module. The transmitter and processor normally operate in a sleep mode. The low power receiver receives data and stores the received data in a memory within the low power receiver. Whenever a wakeup time occurs, the transmitter and the processor are put in an operational mode, sensory data is obtained from the sensing module, the sensory data is processed, the received data is obtained from the memory, the processed sensory data and the received data are transmitted via the transmitter, and the transmitter and the processor are put in the sleep mode.

Yet another embodiment of the present invention provides a sensor network that includes a sink node and two or more sensors forming a wireless communications network with the sink node. Each sensor includes a transmitter, a low power receiver, a sensing module and a processor communicably coupled to the transmitter, the low power receiver and the sensing module. The transmitter and processor normally operate in a sleep mode. The low power receiver receives data and stores the received data in a memory within the low power receiver. Whenever a wakeup time occurs, the transmitter and the processor are put in an operational mode, sensory data is obtained from the sensing module, the sensory data is processed, the received data is obtained from the memory, the processed sensory data and the received data are transmitted via the transmitter, and the transmitter and the processor are put in the sleep mode.

The present invention is described in detail below with reference to the accompanying drawings.

### BRIEF DESCRIPTION OF THE DRAWINGS

The above and further advantages of the invention may be better understood by referring to the following description in conjunction with the accompanying drawings, in which:

FIG. 1 is a block diagram of a sensor node in accordance with one embodiment of the present invention;

FIG. 2 is an illustration of a system for asynchronous network operation in accordance with another embodiment of the present invention;

FIG. 3 is a flow chart of a method for asynchronous communication in accordance with yet another embodiment of the present invention;

FIG. 4 is a flow chart of a method for asynchronous communication in accordance with yet another embodiment of the present invention;

FIG. 5 is a flow chart of a method for asynchronous communication in accordance with another embodiment of the present invention;

FIG. 6 is a block diagram of a sensor node in accordance with another embodiment of the present invention;

FIG. 7 is an illustration of an asynchronous wakeup and communications in accordance with one embodiment of the present invention;

FIGS. 8A and 8B are graphs illustrating the effects of a on time period allocation in accordance with on embodiment of the present invention;

FIGS. 9A and 9B illustrate examples of wakeup schedules for various group sized in accordance with one embodiment of the present invention; and

FIGS. 10A, 10B and 10C are graphs illustrating the results of a simulation in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. The discussion herein relates primarily to wireless sensor networks, but it will be understood that the concepts of the present invention are applicable to any asynchronous communication system.

The present invention employs lower power radio and store-and-forward processes to provide an asynchronous communication architecture for wireless sensor networks, where sensor nodes are allowed to independently transmit without requiring any synchronized sleep/wakeup. Specifically, the transmitter directly writes data into a special module residing on the receiver while it is asleep. This way, each individual sensor can schedule its own transmission without demanding network wide or local synchronization. The result is a store-and-forward, asynchronous communication pattern in the network. Owing to the low duty cycle of a sensor node, this architecture can dramatically reduce collisions and idle listening by fully exploiting time as an additional dimension of resource and hence achieve significant energy efficiency.

Understandably, the asynchronous communication architecture will require different hardware modules (in particular low power passive reception modules), MAC layer design, and overlaying computing paradigms. For the low power reception module, instead of starting from scratch, available low power components, namely semi-passive RFID, currently available as off-the-shelf products can fulfill the requirements for passive reception of data frames with desired energy efficiency. For the MAC layer design, the challenges in temporal irregularity using this asynchronous communication architecture, where long delay of data forwarding can occur, are discussed. There are two solutions to these challenges: coordinated random wakeup schedule and interleaved wakeup schedule for different application requirements. Using these approaches, traditional MAC layer operation can be avoided and both energy and delay can be significantly reduced. Other design challenges will also be discussed.

Motivated by the unique, low-data-rate characteristic of a large portion of monitoring applications of wireless sensor networks, the present invention provides an asynchronous communication architecture that can achieve ultra energy efficiency. In this architecture, a transmitter is allowed to directly write data into a special module residing on the receiver while it is asleep. This way, each individual sensor can schedule its own transmission without demanding network wide or local synchronization. The result is a store-and-forward, asynchronous communication pattern in the network.

The key idea of asynchronous communication is to allow a receiving node to largely remain asleep while passively accepting data. The key enabler of this is a module called Passive RadiO Uni-Direct access module—PROUD, which consumes little energy for passive data reception. In principle, a sensor node will have PROUD in conjunction with the conventional radio components such as those on Mica2 motes: PROUD will be responsible for receiving while the conventional radio for transmitting. One additional benefit of this design is backward compatibility: the PROUD module can be simply disabled and existing communication can take place over the conventional radios.

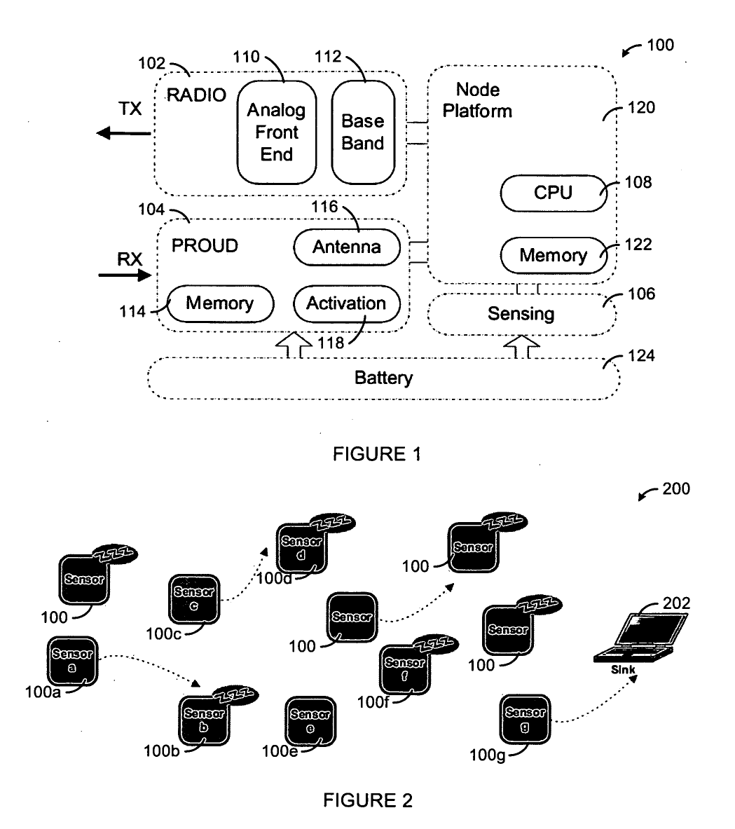

Now referring to FIG. 1, a block diagram of a sensor node 100 in accordance with one embodiment of the present invention is shown. The sensor 100 includes a transmitter 102, a low power receiver (PROUD module) 104, a sensing module 106 and a processor (CPU) 108 communicably coupled to the transmitter 102, the low power receiver 104 and the sensing module 106. The transmitter 102 typically includes an analog front end 110 and base band 112. The low power receiver (PROUD module) 104 typically includes a memory 114, an antenna 116 and an activation module 118. The node platform 102 includes the processor 108 and a memory 122. The components of the sensor 100 are powered by battery 124. In operation, the transmitter 102 and processor 108 normally operate in a sleep mode. The low power receiver 104 receives data and stores the received data in the memory 114 within the low power receiver 104. Whenever a wakeup time occurs, the transmitter 102 and the processor 108 are put in an operational mode, sensory data is obtained from the sensing module 106, the sensory data is processed, the received data is obtained from the memory 118, the processed sensory data and the received data are transmitted via the transmitter 102, and the transmitter 102 and the processor 108 are put in the sleep mode. The sensor 100 determines the wakeup time without synchronization with the wireless network or one or more local sensors. The wakeup time is determined randomly, based on a coordinated wakeup schedule, or an interleaved wakeup schedule.

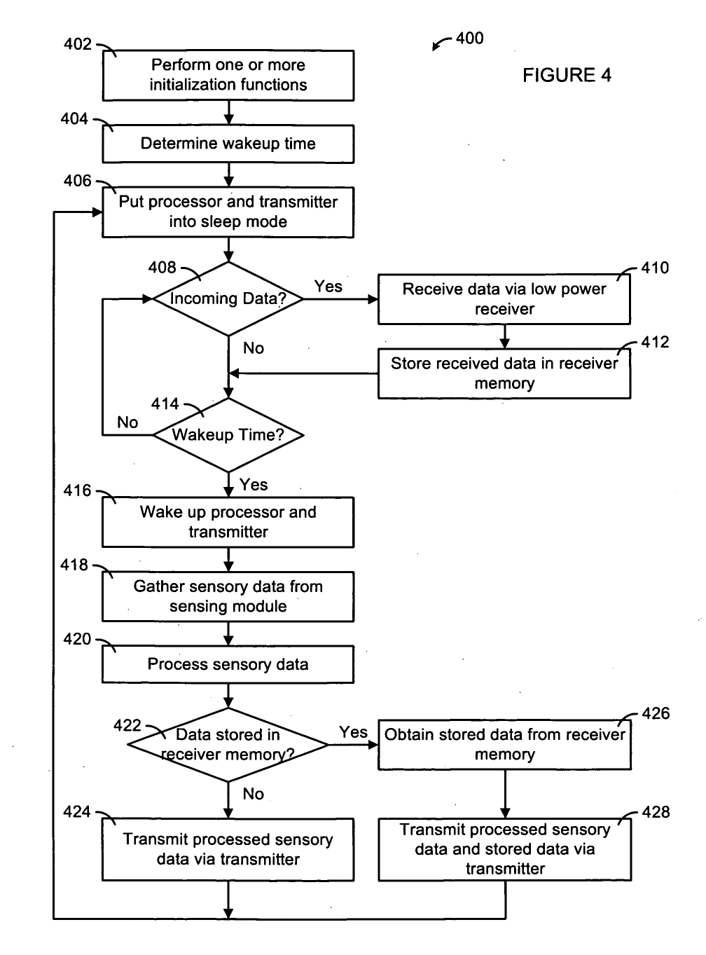

Referring now to FIG. 2, an illustration of a system 200 for asynchronous network operation in accordance with another embodiment of the present invention is shown. The sensor network 200 includes a sink node 202 and two or more sensors 100 forming a wireless communications network with the sink node 202. The sink node 202 can be any communications or computing device (e.g., computer, controller, data acquisition system, etc.) configured to communicate with the sensors 100 and provide an interface to the outside world (i.e., outside of the wireless sensor network). As described in reference to FIGS. 1 and 4, each sensor 100 includes a transmitter 102, a low power receiver 104, a sensing module 106 and a processor 108 communicably coupled to the transmitter 102, the low power receiver 104 and the sensing module 106. The transmitter 102 and processor 108 normally operate in a sleep mode. The low power receiver receives data and stores the received data in a memory within the low power receiver. Whenever a wakeup time occurs, the transmitter 102 and the processor 108 are put in an operational mode, sensory data is obtained from the sensing module 106, the sensory data is processed, the received data is obtained from the memory 118, the processed sensory data and the received data are transmitted via the transmitter 102, and the transmitter 102 and the processor 108 are put in the sleep mode. The sensor 100 determines the wakeup time without synchronization with the wireless network or one or more local sensors. The wakeup time is determined randomly, based on a coordinated wakeup schedule, or an interleaved wakeup schedule.

In this architecture 200, sensor nodes 100, for example node 100a, can wake up at its own schedule, transmit directly a frame over the air interface to the intended receiver 100b's PROUD module. Receiver 100b, when waking up at its own schedule, will collect data stored by the PROUD module, and relay through its main radio to the next hop. This store and forward operation will result in multi-hop communications in an asynchronous manner. In addition to this radio-PROUD communication, radio-radio communication is possible in the architecture, and can be employed to supplement the main radio-PROUD communication method.

As will be detailed later, in this asynchronous communication, there is no need of any conventional MAC layer function such as carrier sensing and collision avoidance. A node will simply wake up and transmit immediately—the collision probability will be extremely low due to the full utilization of the time line (a node's communication is no longer limited to be within the active window). This will simplify the transmission and reception procedure and hence achieve energy efficiency. Note that this asynchronous communication architecture is intended for low data rate applications, such as humidity and temperature monitoring. In these applications, the sampling frequency of the physical environment is low and the data frame size generally is small. These well suits the characteristic of the described PROUD module and also benefit significantly the reduction of collision when nodes will randomly transmit.

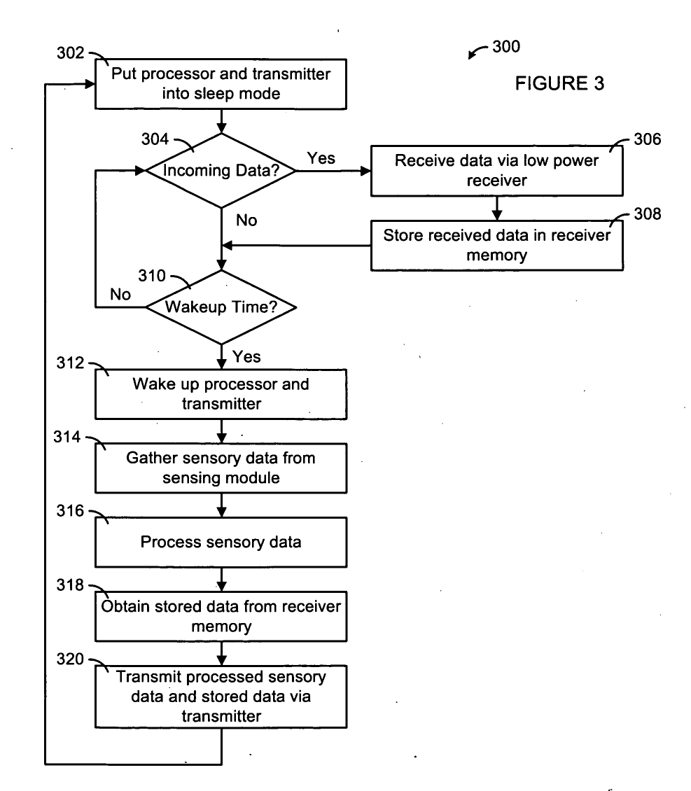

Referring now to FIG. 3, a flow chart of a method 300 for asynchronous communication in accordance with yet another embodiment of the present invention is shown. The processor 108 and transmitter 102 are put into sleep mode in block 302. If incoming data is received, as determined in decision block 304, the data is received via the low power receiver in block 306 and the received data is stored in the receiver memory 114 in block 308. Thereafter, or if no data is received, as determined in decision block 304, and a wakeup time occurs, as determined in decision block 310, the transmitter 102 and the processor 108 are put in an operational mode in block 312. If however, it is not time to wakeup, as determined in decision block 310, the process continues to wait for incoming data in decision block 304 and to wake up in decision block 310. After the processor 108 and the transmitter 102 wake up, sensory data is obtained from the sensing module 106 in block 314, the sensory data is processed in block 316, the received data is obtained from the low power receiver memory 114 in block 318, and the processed sensory data and the received data are transmitted via the transmitter 102 in block 320. Thereafter, the transmitter 102 and the processor 108 are put in the sleep mode in block 302 and the process continues as previously described. Note that this method can be implemented using a computer program embodied on a computer readable medium wherein the steps are performed by one or more code segments.

The operations of a basic wireless sensor network overlaying this asynchronous communication architecture in accordance with another embodiment of the present invention will now be described in more detail.

Bootstrapping: Upon deployment, each sensor will remain awake for an extended period of time, performing initialization functions including neighbor and route discovery, synchronization, cluster formation, and localization. Notice that during this period of time, radio-radio or radio-PROUD communications can both be employed. The network operation during this bootstrapping phase shall be similar to traditional sensor networks as communications are synchronized between a receiver and a transmitter.

Sensing and Information Reporting: After the bootstrapping phase, each sensor node will select an initial wake up time t uniformly random over [0, T], where T denotes the cycle of each sensory data reporting round. Note that different distributions can be designated to achieve various objectives. Each sensor will then periodically wake up after T time to report its data, by unicasting through the sensor radio to the next hop's PROUD module, or performing multicast as demanded. Naturally, data received by the PROUD module from other nodes shall also be relayed during this time period, likely after aggregation.

Single Hop Operations: A sensor node will perform the following operations upon wake up.

Harvesting Data on PROUD: During the sleeping period, the PROUD module may have received multiple frames sent by neighboring sensor nodes. The sensor node shall access the memory and perform data transfer to the main platform if needed. Furthermore, the data can be analyzed and processed (for example, aggregated), dependent on the application.

Transmitting and Addressing: To transmit a frame (either unicast or multi-cast), a sensor node will simply transmit using the sensor radio to the intended receiving node's PROUD module during the awake period. Notice that before transmitting, a sensor node does not need to perform any traditional MAC functions such as carrier sensing or collision avoidance mechanism. Owing to the low duty cycle of a sensor node and spreading of the transmissions along the full time line, collision probability will be very small. Furthermore, it is assumed that a frame can be properly addressed, either by including the destination node's ID or other information according to the network requirement.

Receiving and Filtering: A sensor node receives through PROUD while the main platform remains asleep. Due to the power and design constraint of PROUD, only lower data rate reception is feasible (on the order of tens of Kbs). While the function of the PROUD module may be limited, it is expected to possess simple filtering mechanisms so that irrelevant frames will not be processed and stored in its memory. Simple destination ID based filtering can effectively suffice the needs. As the MAC operation is very simple, rejecting irrelevant frames directly at the PROUD module without further processing will not disturb the network operation, unlike other MAC designs such as IEEE 802.11.

Multi-hop Network Operation: The multi-hop operation of the network is a composition of multiple single hop operations, namely receive-wakeup-transmit-sleep. To determine information routes, any efficient, existing routing schemes, either through the cluster heads in a hierarchical scheme or directly to a neighboring sensor can be employed. For example, LEACH [19] or Directed Diffusion [17] can be easily adopted. However, potential irregular delays along different routes owing to the asynchronous communication pattern may demand innovative routing schemes to be designed. This will be further discussed in the next section.

In the above description, potential collisions and frame errors have been ignored for simplification. Indeed collision probability is very low among sensor nodes due to the spreading of transmission over the entire time line. Also, due to the targeted low data rate, strong forward error correction (FEC) code can be employed to significantly reduce error probability. Nonetheless, if stronger reliability is demanded, acknowledgement schemes can be easily adopted.

Very Low Collision Probability: Owing to the low duty cycle of a sensor node, asynchronous allows sensor nodes to determine their own transmission schedule, and thus liberates the network from collisions and idle listening by fully utilizing the time resource. Indeed, near collision-free transmission can be achieved. For example, considering 50 sensor nodes within interfering communication range, a 50 ms transmission time with a 10 minute sleep period will result in a successful transmission probability for a node at more than 99%. In addition, packet filtering can be easily built into the reception logic of the PROUD module so that unintended receivers will not decode the data. Furthermore, reliability can be achieved by sending ACK frames in a similar asynchronous manner.

Acknowledgement for Reliability: Certainly, error probability in the communication can be reduced through strong forward error control. This is particularly desirable given that the data rate is expected to be low. Regardless, if high degree of reliability is desired, the sender can require an acknowledgement frame from the receiver. This requirement can be easily specified using a designated field in the frame format for the acknowledging policy. After receiving such a frame, the receiver shall send an ACK frame back to the sender. Notice that this data-ack exchange sequence is again performed in an asynchronous manner: the ACK frame will only be transmitted after the receiver wakes up. And this ack actually can be piggybacked with other data transmissions.

Collision Detection and Rescheduling: A sender can detect collision by observing consecutive missing ACKs or missing data reports, although the probability is low due to the nature of the design as described above. If indeed a collision occurs, the sender shall select another wakeup time randomly to avoid further collisions.

Now referring to FIG. 4, a flow chart of a method 400 for asynchronous communication in accordance with another embodiment of the present invention is shown. One or more initialization functions, such as neighbor and route discovery, synchronization, cluster formation, or localization, are performed in block 402. A wakeup time is determined for the sensor 100 in block 404. The wakeup time can be determined randomly, based on a coordinated wakeup schedule, or an interleaved wakeup schedule. The processor 108 and transmitter 102 are put into sleep mode in block 406. If incoming data is received, as determined in decision block 408, the data is received via the low power receiver in block 410 and the received data is stored in the receiver memory 114 in block 412. Thereafter, or if no data is received, as determined in decision block 408, and a wakeup time occurs, as determined in decision block 414, the transmitter 102 and the processor 108 are put in an operational mode in block 416. If however, it is not time to wakeup, as determined in decision block 414, the process continues to wait for incoming data in decision block 408 and to wake up in decision block 414. After the processor 108 and the transmitter 102 wake up, sensory data is obtained from the sensing module 106 in block 418 and the sensory data is processed in block 420. For example, the data processing functions may include a minimum and maximum calculation, an average calculation, a summation calculation, a count, a data compression, a target detection, a classification, a tracking function, an adaptive scheduling function, a collaborative signal processing function, etc. If no data is stored in the receiver memory 114, as determined in decision block 422, the processed sensory data is transmitted via the transmitter 102 in block 424. If however, data is stored in the receiver memory 114, as determined in decision block 422, the received data is obtained from the low power receiver memory 114 in block 426, and the processed sensory data and the received data are transmitted via the transmitter 102 in block 428. After the transmission in block 424 or block 428, the transmitter 102 and the processor 108 are put in the sleep mode in block 406 and the process continues as previously described. Note that this method can be implemented using a computer program embodied on a computer readable medium wherein the steps are performed by one or more code segments.

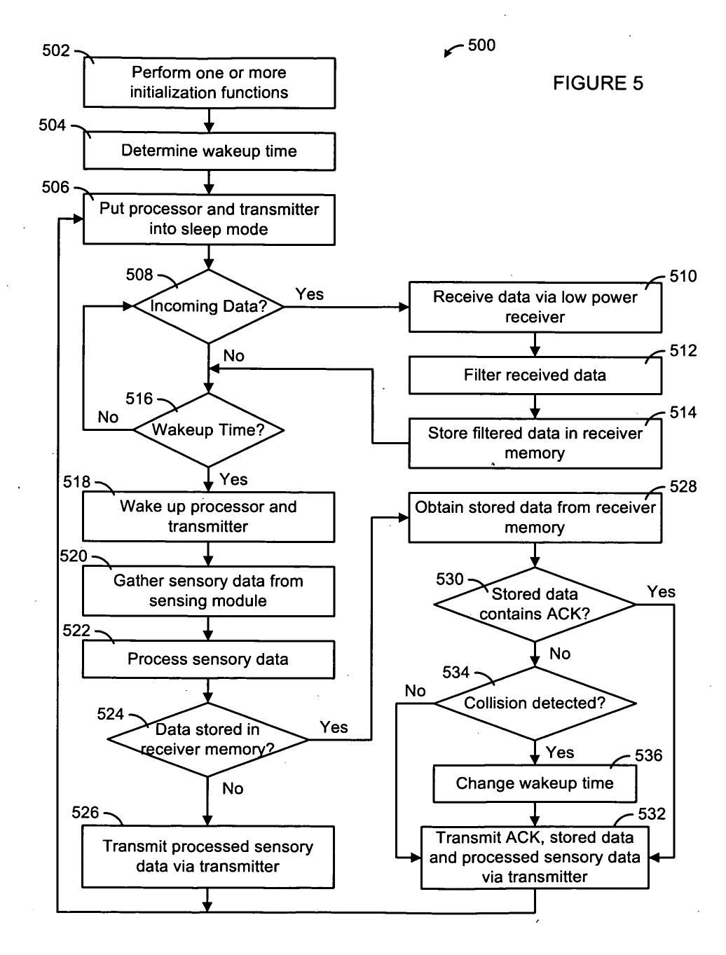

Referring now to FIG. 5, a flow chart of a method for asynchronous communication in accordance with yet another embodiment of the present invention is shown. One or more initialization functions, such as neighbor and route discovery, synchronization, cluster formation, or localization, are performed in block 502. A wakeup time is determined for the sensor 100 in block 504. The wakeup time can be determined randomly, based on a coordinated wakeup schedule, or an interleaved wakeup schedule. The processor 108 and transmitter 102 are put into sleep mode in block 506. If incoming data is received, as determined in decision block 508, the data is received via the low power receiver in block 510, the received data is filtered in block 512 and the received data is stored in the receiver memory 114 in block 514. Thereafter, or if no data is received, as determined in decision block 508, and a wakeup time occurs, as determined in decision block 516, the transmitter 102 and the processor 108 are put in an operational mode in block 518. If however, it is not time to wakeup, as determined in decision block 516, the process continues to wait for incoming data in decision block 508 and to wake up in decision block 516. After the processor 108 and the transmitter 102 wake up, sensory data is obtained from the sensing module 106 in block 520 and the sensory data is processed in block 522. For example, the data processing functions may include a minimum and maximum calculation, an average calculation, a summation calculation, a count, a data compression, a target detection, a classification, a tracking function, an adaptive scheduling function, a collaborative signal processing function, etc. If no data is stored in the receiver memory 114, as determined in decision block 524, the processed sensory data is transmitted via the transmitter 102 in block 526. If however, data is stored in the receiver memory 114, as determined in decision block 524, the received data is obtained from the low power receiver memory 114 in block 528. If the stored data contains an acknowledgement, as determined in decision block 530, the processed sensory data and the received data are transmitted via the transmitter 102 in block 532. If, however, the stored data does not contain an acknowledgement, as determined in decision block 530, and a collision is not detected, as determined in decision block 534, the processed sensory data and the received data are transmitted via the transmitter 102 in block 532. If, however, a collision is detected, as determined in decision block 534, the wakeup time is changed in block 536 and the processed sensory data and the received data are transmitted via the transmitter 102 in block 532. A collision can be detected whenever consecutive acknowledgements are not received, one or more data reports are not received, or a combination thereof. Note that an acknowledgement can be transmitted to a source of the received data during the wakeup time. After the transmission in block 526 or block 532, the transmitter 102 and the processor 108 are put in the sleep mode in block 506 and the process continues as previously described. Note that this method can be implemented using a computer program embodied on a computer readable medium wherein the steps are performed by one or more code segments.

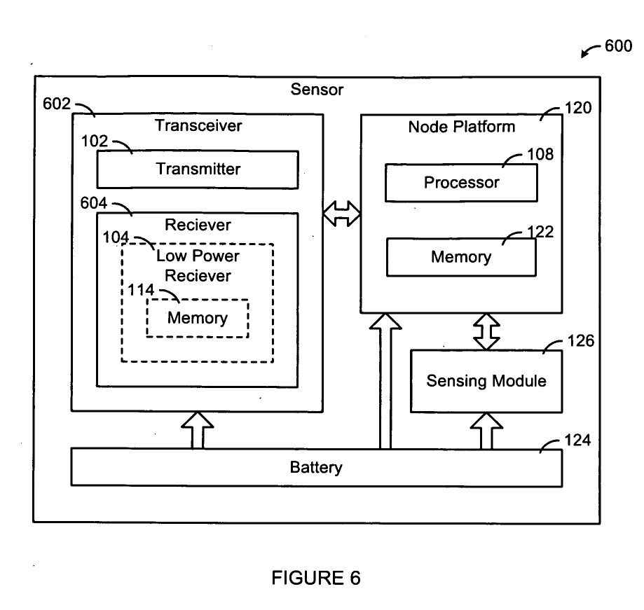

Referring now to FIG. 6, a block diagram of a sensor node 600 in accordance with another embodiment of the present invention is shown. The sensor 600 includes a transceiver 602, a node platform 120, a sensing module 106 and a battery 124. The transceiver 602, node platform 120 and sensing module are communicably couple to one another. The transceiver 602 includes a transmitter 102, a receiver 604 and a low power receiver (PROUD module) 104 having a memory 114. The node platform includes a processor 108 and a memory 122. In operation, the sensor 600 can perform any of the methods previously described in reference to FIGS. 3, 4, 5 or any combination thereof. Moreover, the low power receiver 104 is capable of being disabled such that the transceiver 602, the other receiver 604 and the processor 102 are put in the operational mode.

The PROUD module is the key enabler for the described asynchronous communication architecture. Below, existing technologies that can be modified to fulfill the requirements of passive reception of data frames with desired energy efficiency are described. With recent advancements in lower power radio and activation logic design, a few candidates indeed exist.

Several projects have investigated the design and development of ultra efficient wake-up radio. The function of such radio is to detect meaningful signal on the wireless interface and wake up the main platform in response. For example, the Pico-Radio project at Berkeley claimed that only 1 μw is needed for operating the receiving end of the wakeup radio [23, 27]. Another project [24], based on an idea similar to RFID, proposes to harvest the energy from the radio frequency directly and use it to trigger the main sensor module. This paper contains extensive analysis on the feasibility of using existing sensor radios (such as those on Mica2) for this purpose. However, these approaches are mainly used for detection of the signal, not data reception. If such modules are employed for developing the PROUD module, extensive enhancements including data reception must be added. Also, they are still in the preliminary stage focusing more on feasibility and theoretical analysis.

A much more mature technology is RFID [28]. However, passive RFID tags rely mainly on absorbing energy from the reader's electromagnetic field, which requires high power transmission from the reader. In wireless sensor networks, such requirement cannot usually be satisfied. Active RFID tags, on the other hand, in principle are the same as traditional wireless equipments, purely relying on their own energy sources for transmission and reception. For the purpose of the PROUD module, semi-passive RFID tags serve as an ideal technology candidate. The key difference between semipassive and passive RFID tags lies in the availability of battery energy source. This battery energy source supplies the DC power to the tag circuit, eliminating the requirement of drawing the energy from the radio frequency field. At the same time, different from active tags, the received signal will be used to trigger the tag for commanded operations. Indeed, semi-passive tags with both read and write capability are readily available as off-the-shelf products. For example, the INTELLEFLEX (www.intelleflex.com) tag has up to 64 KB read/write user memory and a life time of several years dependent on a thin film battery.

Another advantage of semi-passive RFID tags is the extended range as compared to pure passive ones. Given the functionality of the PROUD module, the communication distance is essentially determined by the required power to excite the passive receiver. This receiving power Pᵣ is given by

$${P}_{r} = \frac{{λ}^{2} {P}_{t} {G}_{t} {G}_{r}}{{( 4 π D )}^{2}} ,$$

where Pₜ is the transmitting power, Gₜ and Gᵣ are the transmitter and receiver antenna gains respectively, λ is the wavelength, and D is the distance between the transmitter and receiver. Given the limited transmission power of the sensor radio, a pure passive PROUD module can at most achieve a communication range of a few meters, due to the requirement of high Pᵣ for excitement. On the contrary, semi-passive RFID tag employs a battery powered receiver gain block (amplifier) that can significantly increase the sensitivity of the tag, or equivalently achieve significant reduction in required Pᵣ (30 dB reduction is currently achievable). In turn, the communication range can be greatly extended. Using INTELLEFLEX's semi-passive tag and assuming a transmission power of 10 mw (the transmission power of current Mica2 node), a 50 ft communication range is readily achievable, which suffices most sensor network applications. Notice that the power consumption of the receiver gain block can be extremely low. Nanowatt power amplifiers are readily available currently, for example, from TEXAS INSTRUMENTS.

Furthermore, as the system's requirement is only on writing to the tag, not reading, information backscattering from the tag is not needed. This in turn will eliminate any requirement for sophisticated receiving module at the transmitting node. The radio module for current wireless sensor platforms such as Mica2 will suffice as the writer, requiring limited modification and tuning.

The feasibility and methods for designing the PROUD module based on INTELLEFLEX's semi-passive RFID have been analyzed. INTELLEFLEX provides a single chip solution for the semi-passive RFID and this chip can be solely employed as a RF modem for receiving and transmitting. The performance including power consumption, range (50 ft communication range at 10 mw transmission power), and sensitivity also satisfy the system requirements. A sensor node has been prototyped, which has been thoroughly tested and is fully functional. Leveraging this, the sensor node can be designed so that it can seamlessly integrate with the PROUD module. In this example, the CC1110 chip operating at 900 MHz from TEXAS INSTRUMENTS is used in order to communicate with the INTELLEFLEX semi-passive RFID (operating at 900 MHz). The CC1110 is tuned toward required modulation and coding schemes as defined for semi-passive RFID.

Changing the underlying communication inevitably will affect higher layer designs as well. Due to asynchronous wakeup time and communication pattern, multi-hop communication can introduce undesirable delay and out-of-order receptions of sensory data. Furthermore, as the wakeup times of the sensor nodes are not synchronized, sensing the data of interests will be performed at different time points, which will result in irregular temporal pattern.

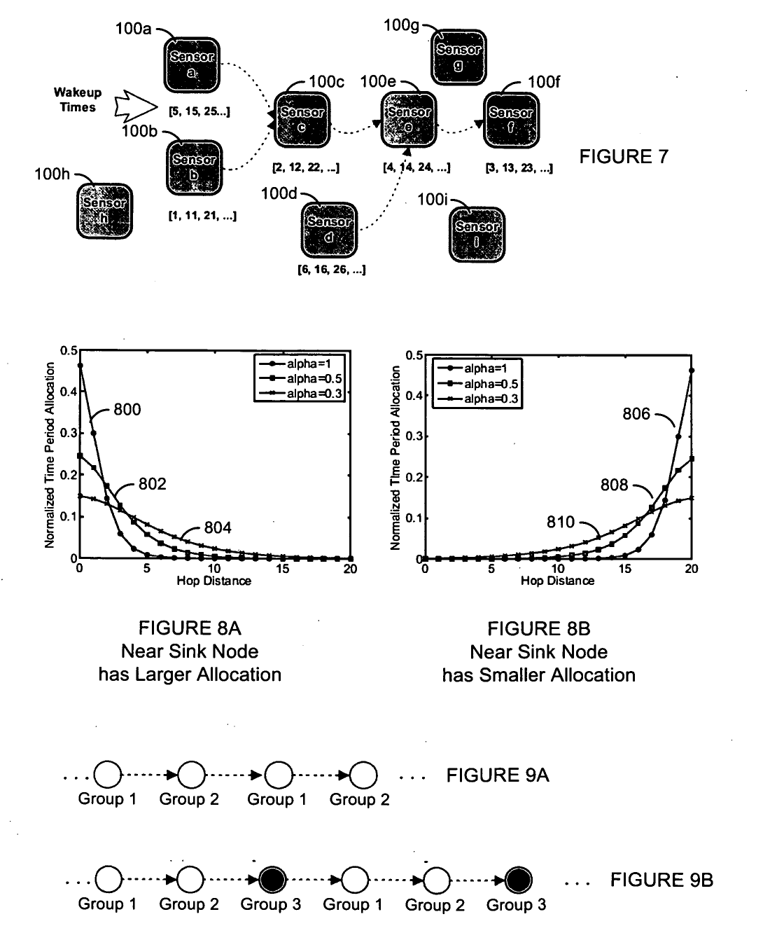

Referring now to FIG. 7, an illustration of an asynchronous wakeup and communications 700 in accordance with one embodiment of the present invention is shown. Assume that sensor nodes 100 wake up every 10 s (a round time) with initial time randomly chosen. Each node's independent schedule is shown below the node in the figure. Upon waking up, a node 100 will gather sensory data from its sensing module. Let Iₐ(t) denote the sensory data gathered by node 100a at time t. At the same time, it will also harvest data received on the PROUD module and perform data transmission during the awake period. In this procedure, the asynchronous wakeup pattern among the nodes will create unexpected delays. For example, at time 5s, sensor node 100a will wake up and send its sensory data Iₐ (5) to node 100c. As node 100c's wakeup times are [2s, 12s, . . . ], although its PROUD module will receive node 100a's data at time 5s, it will only be able to read, process and forward them at time 12s. On the contrary, when node 100c wakes up at time 12s, the sensory data received from node 100b will be I_{b}(11), gathered at time 11s. Therefore, at node 100c, node 100a's sensory data will always be one round lagging behind node 100b's data. In other words, when node 100c wakes up at time (10n+2), its PROUD module will contain Iₐ(10(n−1)+5) and I_{b}(10n+1), where n is a positive integer. Indeed, whenever the receiver's wake up time is behind that of the transmitter, a delay of a round will be created in receiving and relaying the data. For a multi-hop communication, this delay at each hop will be superimposed. Therefore, at node 100f, the sensory data on the PROUD at a particular wakeup point, say 23s, may consist of [Iₐ(5), I_{b}(11), I_{c}(12), I_{d}(6), Iₑ(14)], and I_{f}(23) gathered by sensor 100f itself. A snapshot of sensory data available to a node 100 at its wakeup time in a round is as follows:

| Node ID | Wakeup Time | Sensory Data |
|---|---|---|
| 100a | 25 | Iₐ(25) |
| 100b | 21 | I_{b}(21) |
| 100c | 22 | [Iₐ(15), I_{b}(21), I_{c}(22)] |
| 100d | 26 | I_{d}(26) |
| 100e | 24 | [Iₐ(15), I_{b}(21), I_{c}(22), I_{d}(16)] |
| 100f | 23 | [Iₐ(5), I_{b}(11), I_{c}(12), I_{d}(6), Iₑ(14), I_{f}(23)] |

As shown in this simple example, due to the asynchronous wakeup pattern among different nodes, sensory data will be gathered at different time points, which will introduce temporal irregularity in the network. Moreover, while the sensory data is being forwarded in the network, different delay will be introduced owing to the asynchronous communication pattern. This delay is different from one route to another. Consequently, the sensory data received by a sensor node's PROUD module may be composed of those from multiple sensor nodes at different time points. It is evident that varying delays introduced by the asynchronous communication pattern are inherent. For a simple store-and-forward network, this problem may be insignificant. Unfortunately, a majority of sensor networks also demand additional services such as routing, synchronization, query processing, and complex in-network processing techniques including data aggregation, classification, and detection.

Below, two solutions are outlined that can streamline data forwarding in this asynchronous communication architecture: if in-network processing is performed and sensory data can be effectively aggregated along the routing path, coordinated random wakeup can be used; if in-network processing is not favorable in the application, interleaved wakeup schedule can be used where nodes will wake up more frequently to check if there is data to be forwarded.

Note that if hierarchical network architectures (exemplified by the Tenet design from USC where super nodes act as cluster heads) are employed, the above problem will be less severe. However, the problem may still needs to be addressed as each cluster may still employ multi-hop communication for cluster members to forward data to the cluster head. Notice that asynchronous communication (radio to PROUD) will have smaller distance than conventional communication (radio to radio). This may further necessitate the use of multi-hop communication within a cluster.

Coordinated Random Wakeup: If data aggregation is effective in the network in reducing the data amount, the wakeup schedule of the sensor nodes can be slightly regulated in order to streamline the data forwarding and hence avoid the irregular temporal pattern. The key design idea here is to allow nodes nearer to the sink node along the route to wakeup later than those nodes farther away. As data aggregation can effectively reduce the data amount, this will not create extra large frames in the network. Using this approach, the delay can be reduced to be within one round time.

For the network illustrated in FIG. 7, as long as a node wakes up later than its previous hop in a specific round, the sensory data can be delivered in a timely fashion during that round. The challenge in achieving this is to coordinate the wake up time of multiple sensors in the network, while retaining the benefit of asynchronous communication. The approach toward this is to assign a wakeup period based on the hop distance of a sensor from the sink node: the closer a node is to the sink node, the later it shall wakeup in a specific round. To avoid collisions in a neighborhood formed by nodes with the same hop distance from the sink node, each node is still allowed to randomly choose an initial wakeup time in the allocated period. If a collision is detected, for example, indicated by a missing ACK, a node can randomly choose another time for wakeup and transmission. The time period that should be allocated to nodes with certain hop distance to the sink node will now be briefly discussed.

To measure the hop distance of a node, the sink node can initiate a network-wide broadcast through controlled flooding. In the broadcast packet, the field containing hop distance shall be initially set to zero at the sink node and increased by one for each additional forwarding by an intermediate node. This hop distance can certainly be revised according to the specific routing schemes. Assume that a node's hop distance to the sink node is d, where d is an integer and the time period for a round is T. A node shall select its initial wakeup time ti, as an example, uniformly random from

$$[ 2 T ( 1 - \frac{1}{1 + {e}^{- α ( d - 1 )}} ) , 2 T ( 1 - \frac{1}{1 + {e}^{- α d}} ) ] ,$$

where α>0 is a network and application dependent parameter. This time period for different hop distances will affect potential collision probability and must be chosen carefully. FIG. 8A depicts the effect of a on the time period allocation for a particular hop distance d where the near sink node has a larger allocation. The y-axis denotes fraction of time nodes with corresponding hop distance should obtain. By varying α (plot 800: α=1; plot 802: α=0.5; plot 804: α=0.3), the allocation can be effectively tuned. This is of particular importance in avoiding potential collisions, depending on the network deployment. For example, in FIG. 8A, a larger a will provide a larger period of time for nodes with short hop distance to the sink node; on the contrary, a smaller α will more favor nodes further away from the sink node by allocating more time. If it is desirable that nodes further away from the sink node shall get more time than nodes nearer the sink node, the allocation can be reversed, as shown in FIG. 8B (plot 806: α=1; plot 808: α=0.5; plot 810: α=0.3) where the near sink node has a smaller allocation.

Note that nodes with shorter hop distance are allocated to a later time period in a round, which is necessary for streaming the transmissions. Also, the delay of a packet can be roughly guaranteed to be under one round time T, and T can be effectively tuned to tradeoff delay and energy consumption. Obviously, different formula, instead of the one used above, can be employed for different scenarios.

Interleaved Wakeup Schedule: Unfortunately, if in-network processing is not effective in reducing network load, the above scheme will result in large amount of data on the nodes around the sink node to be transmitted. While this problem is not unique to asynchronous communication, it may be more severe, as this architecture suits better for low rate scenarios and small packets.

To solve this problem, an Interleaved Wakeup Schedule (IWS) scheme is presented that forwards sensory data in an interleaved, hop-by-hop fashion. The basic idea is to allow sensor nodes to wakeup more frequently so that congestion will be alleviated around the sink node. Similar to the random wakeup scheme, each sensor node will wake up periodically with a random chosen initial wakeup time in a round time. The difference, however, lies in the pattern of the wakeup: instead of sharing the round time with all the nodes, only a group of neighboring nodes will share one round time.

Specifically, denote a complete cycle of wakeup and sleep by T_{c}. Let uᵢ denote a sensor node that is i hop away from the sink node on a routing path. The sensor nodes are grouped into different groups, where each group consists of G neighboring nodes. In each group, sensor nodes will be assigned different but consecutive wakeup time windows of size T_{c}/G based on its distance to the sink node. This schedule will then repeat for the next group on the path. This way, the collision probability can be reduced due to spatial reuse of the spectrum and the frequency of wakeup can be controlled by the group size G. Formally, node uᵢ will wake at time tᵢ which is determined by the following formula:

$${t}_{i} ( n ) = U [ 0 , {T}_{c} ] + ( i mod G ) \frac{{T}_{c}}{G} + ( n - 1 ) {T}_{c} \qquad ( 1 )$$

where n=1, 2 . . . , denoting the number of rounds for data gathering. For illustration purpose, let us assume G=2. In this case, nodes that are even hops away from the sink node will randomly wakeup in one time window T_{c}/2 and nodes odd hops away will randomly wakeup in the follow T_{c}/2 window. This is shown in the FIG. 9A. Indeed, using a group size of 2 potentially have the hidden terminal problem where transmissions can collide at a receiver. In this case, a larger group size can be employed. FIG. 9B shows the case for group size of 3.

Note that round time and group size can be effective control parameters on node wakeup frequency. In the extreme case where all nodes fall in one group, it becomes similar to the coordinated wakeup schedule. On the other hand, if each node is one group, it degenerates into the basic operation where no regulation is employed. Regardless of the group size, in each round, a data frame will be forwarded one hop toward the sink node. It is then easy to verify that regardless of the group size, over an H hop path, the expectation of the delay incurred by a data frame will be proportional to HT_{c}.

With the underlying asynchronous communication the overlaying computing scheme presents novel challenges as well. These include localization, synchronization, distributed computing, signal processing, and security.

In-network data processing targets at curtailing the network load by performing data processing at the sensor nodes themselves [29-32]. This includes aggregation operations such as min/max, average, sum, and count, and more advanced techniques including collaborative signal processing such as joint data compression, target detection, classification, and tracking. Extensive efforts have been devoted toward this end, notably among which are data compression, adaptive scheduling, and collaborative signal processing [33-38].

From pure information theoretic point of view, the described asynchronous operation in the proposed architecture provides another approach for reducing redundancy of sensory data by introducing asynchronism. The reason can be briefly outlined as follows. Aside from the spatial correlation among sensor nodes, temporal correlation is also presented in sensory data due to the nature of the physical phenomena observed by sensor nodes. When performing asynchronous sampling strategy, each sensor node samples the interested field at different time points. Compared with synchronized operation where sensor nodes sample the physical field at the same time, the temporal correlation among the sensory data can be effectively reduced. The benefits are either reduced sampling rate for energy efficiency or increased entropy (amount of information) for better system performance.

Still, with asynchronous sampling, the spatial, temporal distributed sensory data available to a sensor node at a particular time point is heavily dependent on the routing scheme and the wakeup schedule of the intermediate nodes, which has already been clearly shown in FIG. 7. As these schemes often cannot be precisely controlled, the in-network processing scheme must be capable of accommodating irregular patterns in both the temporal and spatial domains. Processing such data in terms of both aggregation (e.g., calculating the average) or compression (e.g., wavelet transform) demands innovative solutions.

Some simulation results of the proposed data streamlining schemes will now be discussed. The asynchronous communication architecture is implemented in OMNeT++, where the PROUD module is implemented as an additional receiving module for a sensor node. The simulated network consists of 1000 sensor nodes. These nodes are distributed randomly over a 0.5 km by 0.5 km square area. The transmission ranges for asynchronous communication (using PROUD for reception) and synchronous communication (SMAC and 802.11 using conventional radio) are 30 meters and 90 meters respectively. The parameters used in the simulation are summarized in Table I. Notice that these parameters, in particular those for the power consumptions, are fairly realistic given current state of arts in this domain.

TABLE I
PARAMETER SUMMARY IN SIMULATION

| Parameter | Values | |
|---|---|---|
| Link Speed | 20 | Kbps |
| Sleep State Power Consumption | 0.05 | mw |
| RX State Power Consumption (PROUD) | 0.4 | mw |
| RX State Power Consumption (Radio) | 25 | mw |
| TX State Power Consumption | 38 | mw |
| MAC Header Size | 8 | Bytes |
| Payload Data Size | 30 | Bytes |

| | |
|---|---|
| Duty Cycle | 5% (S-MAC and IWS-2) |

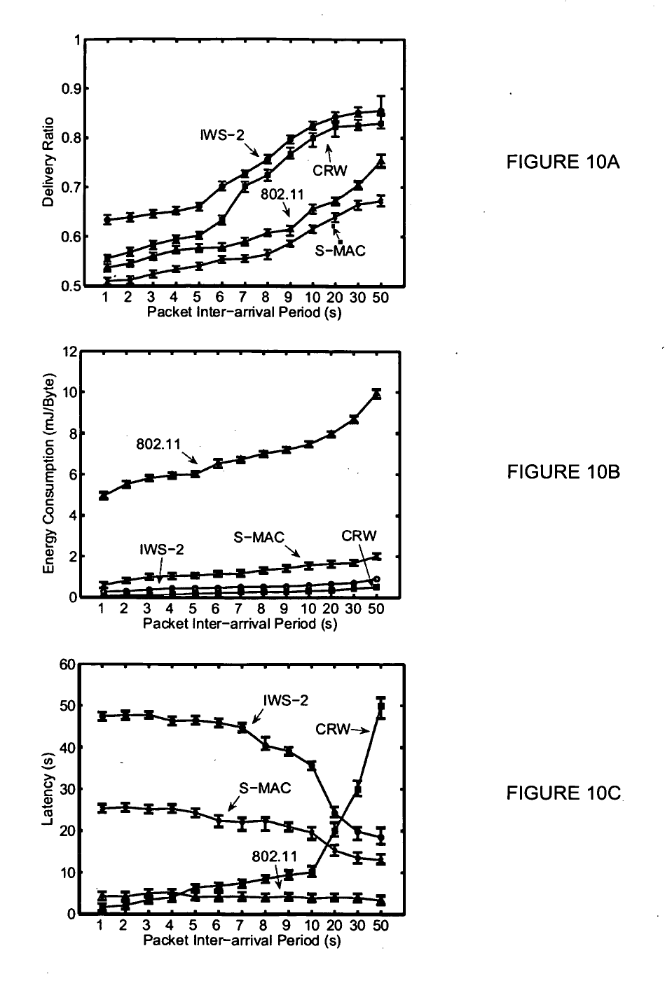

The coordinated random wakeup was implemented with α=0.2 (denoted by CRW), and the interleaved data forwarding schemes at 5% duty cycle with group size G=2 and T_{c}=4 s (denoted by IWS-2), and compare their performance in data delivery ratio, energy consumption end-to-end latency with other protocols including 5% duty cycle S-MAC without adaptive listening and 802.11. In the simulation, each node will generate one 30-byte short frame periodically in each round. By varying the round time, i.e., packet inter-arrival time as shown as the x-axis of FIGS. 10A, 10B and 10C, the traffic load can be varied within the network. Notice that in CRW, this round time is simply allocated to all the hops. In-network aggregation is also performed which is emulated by a simple compression algorithm. Each simulation is performed 10 times and the variance of the results is also shown together with the main results in FIGS. 10A, 10B and 10C.

FIG. 10A shows the measured average fraction of nonrepeated packets received by sink node. Note that S-MAC has the lowest packet delivery regardless of the traffic load. 802.11 performs better than S-MAC but still a low percentage of packets. The reason can be partially attributed to the high transmission range and hencemore severe interference. As the time periods allocated to further away nodes are small in CRW in the simulation and also the round time is very small, collision probability is higher in particular when the traffic load is heavy, which results in the low delivery ratio during that range. Notice that this is due to the design to keep the delay under one round time. If this is relaxed, for example allowing longer forwarding time, the delivery ratio will dramatically increase. IWS-2, on the contrary, wakes up more frequently to relay packets in the system and use short hop distance to avoid large scale interference. This result also shows that an asynchronous communication scheme (IWS-2 and CRW) works better under light traffic load which has been previously discussed.

FIG. 10B shows the measured per-byte energy consumption over the entire network for forwarding the data to the sink node. As expected, both CRW and IWS-2 achieve substantial energy savings over other protocols, especially when traffic load is light. Notice that 802.11MAC uses more than twenty times and S-MAC uses more than four times of the energy used by IWS-2 and CRW. CRW is more efficient than IWS-2 as IWS-2 will wakeup more often as decided by the simulation parameters.

As shown in FIG. 10C, due to asynchronous communication pattern and heavy traffic load, IWS-2 has longer delay as compared to others with small inter-arrival time. When the traffic load is less, IWS-2 has better latency performance as the traffic load is decreased. Notice that CRW has latency roughly proportional to the round time per the design. However, the price is low frame delivery ratio as shown in FIG. 10A. As previously discussed, if a guaranteed one round delay time in CRW is not desired, a large time window can be used where collision probability can be significantly reduced then.

### REFERENCES

[1] C. Chong and S. Kumar, “Sensor networks: Evolution, opportunities, and challenges,” Proceedings of the IEEE, vol. 91, no. 8, August 2003.
[2] I. Akyildiz, W. Su, Y. Sankarasubramaniam, and E. Cayirci, “A survey on sensor networks,” IEEE Communications Magazine, vol. 40, no. 8, August 2002.
[3] S. Xu and T. Saadawi, “Revealing the problems with 802.11 medium access control protocol in multi-hop wireless ad hoc networks,” Computer Networks, vol. 38, no. 14, pp. 531-548, 2002.
[4] A. Kherani and R. Shorey, “Throughput analysis of tcp in multi-hop wireless networks with ieee 802.11 mac,” in Proceedings of the IEEE Wireless Communications and Networking Conference, Atlanta, Ga., March 2004.
[5] V. Kanodia, C. Li, A. Sabharwal, B. Sadeghi, and E. Knightly, “Distributed multi-hop scheduling and medium access with delay and throughput constraints,” in Proceedings of ACM MOBICOM, Rome, Italy, 2001.
[6] A. Chandra, V. Gummalla, and J. O. Limb, “Wireless medium access control protocols,” IEEE Communications. Surveys and Tutorials, vol. 3, no. 2, pp. 2-15, 2000.
[7] W. Ye, J. S. Heidemann, and D. Estrin, “An energy-efficient mac protocol for wireless sensor networks,” in Proceedings of IEEE INFOCOM, New York, N.Y., 2002.
[8] W. Ye, J. Heidemann, and D. Estrin, “Medium access control with coordinated adaptive sleeping for wireless sensor networks,” IEEE/ACM Transactions on Networking, vol. 12, no. 3, pp. 493-506, 2004.
[9] A. Woo and D. Culler, “A transmission control scheme for media access in sensor networks,” in Proceedings of ACM MOBICOM, Rome, Italy, 2001.
[10] T. Dam and K. Langendoen, “An adaptive energy-efficient mac protocol for wireless sensor networks,” in Proceedings of ACM Sensys, Los Angeles, Calif., November 2003.
[11] J. Polastre, J. Hill, and D. Culler, “Versatile low power media access for wireless sensor networks,” in Proceedings of ACM Sensys, Baltimore, Md., November 2004.
[12] T. Zheng, S. Radhakrishnan, and V. Sarangan, “Pmac: An adaptive energy-efficient mac protocol for wireless sensor networks,” in Proceedings of IPDPS, Denver, Colo., 2005.
[13] X. Li, P. Wan, Y. Wang, and O. Frieder, “Coverage in wireless ad-hoc sensor networks,” IEEE Transactions on Computers, vol. 52, no. 6, pp. 753-763, 2003.
[14] S. Kumar, T. Lai, and J. Balogh, “On k-coverage in a mostly sleeping sensor network,” in Proceeding of ACM Mobicom, Philadelphia, Pa., October 2004.
[15] D. Tian and N. Georganas, “A coverage-preserving node scheduling scheme for large wireless sensor networks,” in Proceeding of A CM WSNA, Atlanta, Ga., 2002.
[16] C. Intanagonwiwat, D. Estrin, R. Govindan, and J. Heidemann, “Impact of network density on data aggregation in wireless sensor networks,” in Proceedings of ICDCS'02, Vienna, Austria, July 2002.
[17] C. Intanagonwiwat, R. Govindan, D. Estrin, J. Heidemann, and F. Silva, “Directed diffusion for wireless sensor networking,” IEEE/ACM Transactions on Networking, vol. 11, no. 1, February 2003.
[18] S. Lindsey and C. S. Raghavendra, “Pegasis: Power-efficient gathering in sensor information systems,” in Proceedings of IEEE Aerospace Conference, Big Sky, Mont., March 2002.
[19] W. Heinzelman, A. Chandrakasan, and H. Balakrishnan, “Energyefficient communication protocol for wireless microsensor networks,” in Proceedings of the 33rd Annual Hawaii International Conference on System Sciences, Maui, Hi., January 2000.
[20] X. Wang, G. Xing, Y. Zhang, C. Lu, R. Pless, and C. Gill, “Integrated coverage and connectivity configuration in wireless sensor networks,” in Proceeding of ACM Sensys, Los Angeles, Calif., November 2003.
[21] L. Wang and X. Yang, “A survey of energy saving mechanisms in sensor networks,” in Proceedings of IEEE Broadnets, Boston, Mass., October 2005.
[22] J. M. Rabaey, J. Ammer, T. Karalar, L. Suetfei, B. Otis, M. Sheets, T. Tuan, “Picoradios for wireless sensor networks: The next challenge in ultra-low-power design,” in Proceedings of the International Solid-State Circuits Conference, San Francisco, Calif., February 2002.
[23] J. M. Rabaey, M. J. Ammer, J. L. da Silva, Jr., D. Patel, S. Roundy, “Picoradio supports ad hoc ultra-low power wireless networking,” IEEE Computer, vol. 33, no. 7, 2000.
[24] L. Gu and J. Stankovic, “Radio-triggered wake-up capability for sensor networks,” in Proceedings of IEEE RTAS, Toronto, Canada, May 2004.
[25] E. Shih, P. Bahl, and M. J. Sinclair, “Wake on wireless: an event driven energy saving strategy for battery operated devices,” in Proceedings of ACM MOBICOM, Atlanta, Ga., 2002.
[26] R. Zheng, J. C. Hou, and L. Sha, “Asynchronous wakeup for ad hoc networks,” in Proceedings of ACM MobiHoc, Annapolis, Md., 2003.
[27] J. L. da Silva, Jr., J. Shamberger, M. J. Ammer, C. Guo, S. Li, R. Shah, T. Tuan, M. Sheets, J. M. Rabaey, B. Nikolic, A. Sangiovanni-Vincentelli, P. Wright, “Design methodology for picoradio networks,” in Proceedings of ACM, Munich, Germany, 2001.
[28] K. Finkenzeller, RFID Handbook: Fundamentals and Applications in Contactless Smartcards and Identification. Willey and Sons, 2003.
[29] Y. Xu, J. Heidemann, and D. Estrin, “Geography-informed energy conservation for ad hoc routing,” in Proceedings of ACM MOBICOM, Rome, Italy, July 2001.
[30] R. Wagner, S. Sarvotham, and R. Baraniuk, “A multiscale data representation for distributed sensor networks,” in Proceedings of IEEE ICASSP, Philadelphia, Pa., March 2005.
[31] J. Acimovic, R. Cristescu, and B. Lozano, “Efficient distributed multiresolution processing for data gathering in sensor networks,” in Proceedings of IEEE ICASSP, Philadelphia, Pa., March 2005.
[32] H. Luo, Y. Liu, and S. K. Das, “Routing correlated data with fusion cost in wireless sensor networks,” IEEE Transactions on Mobile Computing, vol. 5, no. 11, November 2006.
[33] J. Chou, D. Petrovic, and K. Ramchandran, “A distributed and adaptive signal processing approach to exploiting correlation in sensor networks,” Ad Hoc Networks, vol. 2, no. 4, pp. 387-403, 2004.
[34] J. Barros and S. D. Servetto, “Network information flow with correlated sources,” vol. 52, pp. 155-170, January 2006.
[35] J. Liu, M. Adler, D. Towsley, and C. Zhang, “On optimal communication cost for gathering correlated data through wireless sensor networks,” in Proceedings of MobiCom'06, Los Angeles, Calif., September 2006.
[36] M. Perillo, Z. Ignjatovic, and W. Heinzelman, “An energy conservation method for wireless sensor networks employing a blue noise spatial sampling technique,” in Proceedings of IPSN 2004, Berkeley, Calif., April 2004.
[37] R. Nowak, U. Mitra, and R. Willett, “Estimating inhomogeneous fields using wireless sensor networks,” vol. 22, no. 6, pp. 999-1006, 2004.
[38] H. Gupta, V. Navda, S. R. Das, and V. Chowdhary, “Efficient gathering of correlated data in sensor networks,” in Proceedings of MobiHoc 2005, Urbana-Champaign, Ill., USA, May 2005, pp. 402-413.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the methods disclosed and claimed herein can executed without undue experimentation in light of the present disclosure. While the methods of this invention have been described in terms of preferred embodiments, it will be apparent to those of skill in the art that variations may be applied to the methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present invention have been described in detail, it will be understood by those skilled in the art that various modifications can be made therein without departing from the spirit and scope of the invention as set forth in the appended claims.

What is claimed is:

1. A method for communicating within a wireless network of sensors wherein each sensor comprises a transmitter normally operating in a sleep mode, a low power receiver having a memory, a sensing module, a processor normally operating in a sleep mode communicably coupled to the transmitter, the low power receiver and the sensing module, the method comprising the steps of:
receiving data via the low power receiver;
storing the received data in the memory; and
whenever a wakeup time occurs, putting the transmitter and the processor in an operational mode, obtaining sensory data from the sensing module, processing the sensory data, obtaining the received data from the low power receiver memory, transmitting the processed sensory data and the received data via the transmitter, and putting the transmitter and the processor in the sleep mode.

2. The method as recited in claim 1, wherein the sensor determines the wakeup time without synchronization with the wireless network or one or more local sensors.

3. The method as recited in claim 1, wherein the sensor further comprises:
a transceiver that includes the transmitter, the low power receiver and another receiver normally operating in the sleep mode; and
wherein the low power receiver is a module within the other receiver that is capable of being disabled such that the transceiver, the other receiver and the processor are put in the operational mode.

4. The method as recited in claim 1, wherein the steps of receiving the data and storing the received data occur while the transmitter and the processor are in the sleep mode.

5. The method as recited in claim 1, further comprising the step of performing one or more initialization functions wherein the initialization function(s) comprise a neighbor and route discovery, a synchronization, a cluster formation, or a localization.

6. The method as recited in claim 1, further comprising the step of performing one or more data processing functions wherein the data processing function(s) comprise a minimum and maximum calculation, an average calculation, a summation calculation, a count, a data compression, a target detection, a classification, a tracking function, an adaptive scheduling function or a collaborative signal processing function.

7. The method as recited in claim 1, further comprising the step of determining the wakeup time randomly, based on a coordinated wakeup schedule, or an interleaved wakeup schedule.

8. The method as recited in claim 1, further comprising the step of filtering the received data.

9. The method as recited in claim 1, wherein an acknowledgement is transmitted to a source of the received data during the wakeup time.

10. The method as recited in claim 1, further comprising the step of changing the wakeup time whenever a collision is detected.

11. The method as recited in claim 10, wherein the collision is detected whenever consecutive acknowledgements are not received, one or more data reports are not received, or a combination thereof.

12. A computer program embodied on a computer readable medium for communicating within a wireless network of sensors wherein each sensor comprises a transmitter normally operating in a sleep mode, a low power receiver having a memory, a sensing module, a processor normally operating in a sleep mode communicably coupled to the transmitter, the low power receiver and the sensing module, the computer program comprising:
a code segment for receiving data via the low power receiver;
a code segment for storing the received data in the memory; and
a code segment for whenever a wakeup time occurs, putting the transmitter and the processor in an operational mode, obtaining sensory data from the sensing module, processing the sensory data, obtaining the received data from the low power receiver memory, transmitting the processed sensory data and the received data via the transmitter, and putting the transmitter and the processor in the sleep mode.

13. A sensor comprising:
a transmitter normally operating in a sleep mode;
a low power receiver having a memory that receives data and stores the received data in the memory;
a sensing module;
a processor normally operating in a sleep mode communicably coupled to the transmitter, the low power receiver and the sensing module; and
whenever a wakeup time occurs, the transmitter and the processor are put in an operational mode, sensory data is obtained from the sensing module, the sensory data is processed, the received data is obtained from the memory, the processed sensory data and the received data are transmitted via the transmitter, and the transmitter and the processor are put in the sleep mode.

14. The sensor as recited in claim 13, wherein the sensor determines the wakeup time without synchronization with the wireless network or one or more local sensors.

15. The sensor as recited in claim 13, wherein the sensor further comprises:
a transceiver that includes the transmitter, the low power receiver and another receiver normally operating in the sleep mode; and
wherein the low power receiver is a module within the other receiver that is capable of being disabled such that the transceiver, the other receiver and the processor are put in the operational mode.

16. The sensor as recited in claim 13, wherein the wakeup time is determined randomly, based on a coordinated wakeup schedule, or an interleaved wakeup schedule.

17. The sensor as recited in claim 13, wherein the received data is filtered.

18. The sensor as recited in claim 13, wherein an acknowledgement is transmitted to a source of the received data during the wakeup time.

19. The sensor as recited in claim 13, wherein the wakeup time is changed whenever a collision is detected.

20. The sensor as recited in claim 19, wherein the collision is detected whenever consecutive acknowledgements are not received, one or more data reports are not received, or a combination thereof.

21. A sensor network comprising:
a sink node;
two or more sensors forming a wireless communications network with the sink node; and
wherein each sensor comprises a transmitter normally operating in a sleep mode, a low power receiver having a memory that receives data and stores the received data in the memory, a sensing module, a processor normally operating in a sleep mode communicably coupled to the transmitter, the low power receiver and the sensing module, and whenever a wakeup time occurs, the transmitter and the processor are put in an operational mode, sensory data is obtained from the sensing module, the sensory data is processed, the received data is obtained from the memory, the processed sensory data and the received data are transmitted via the transmitter, and the transmitter and the processor are put in the sleep mode.

22. The sensor network as recited in claim 21, wherein the sensor determines the wakeup time without synchronization with the wireless network or one or more local sensors.

23. The sensor network as recited in claim 21, wherein the sensor further comprises:
a transceiver that includes the transmitter, the low power receiver and another receiver normally operating in the sleep mode; and
wherein the low power receiver is a module within the other receiver that is capable of being disabled such that the transceiver, the other receiver and the processor are put in the operational mode.

24. The sensor network as recited in claim 21, wherein the wakeup time is determined randomly, based on a coordinated wakeup schedule, or an interleaved wakeup schedule.

25. The sensor network as recited in claim 21, wherein the received data is filtered.

26. The sensor network as recited in claim 21, wherein an acknowledgement is transmitted to a source of the received data during the wakeup time.

27. The sensor network as recited in claim 21, wherein the wakeup time is changed whenever a collision is detected.

28. The sensor network as recited in claim 27, wherein the collision is detected whenever consecutive acknowledgements are not received, one or more data reports are not received, or a combination thereof.
